(19) United States
(12) Patent Application Publication
(10) Pub. No.: US 2008/0270767 A1
(43) Pub. Date: Oct. 30, 2008

(54) INFORMATION PROCESSING APPARATUS AND PROGRAM EXECUTION CONTROL METHOD

(75) Inventors: Hajime Sonobe, Tachikawa-shi (JP); Gen Watanabe, Akishima-shi (JP); Tsuyoshi Nishida, Akishima-shi (JP); Kazuyoshi Kuwahara, Akiruno-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/099,093

(22) Filed: Apr. 7, 2008

(30) Foreign Application Priority Data
Apr. 26, 2007 (JP) 2007-117382

(51) Int. Cl. G06F 9/44

(52) U.S. Cl. 712/221; 712/E09.021

(57) ABSTRACT

According to one embodiment, an information processing apparatus includes a first processor which has a first instruction set, a second processor which has a second instruction set, a storage unit which stores a program including a first program module which is described by using the second instruction set and causes the second processor to execute a first process including the arithmetic process, and a second program module which is described by using the first instruction set and causes the first processor to execute a process which is the same as the first process, and a control unit which switches a mode for executing the program between a first mode in which the first program module is assigned to the second processor and a second mode in which the second program module is assigned to the first processor.

### CROSS-REFERENCE TO RELATED APPLICATIONS

This application is based upon and claims the benefit of priority from Japanese Patent Application No. 2007-117382, filed Apr. 26, 2007, the entire contents of which are incorporated herein by reference.

### BACKGROUND

1. Field

One embodiment of the present invention relates to an information processing apparatus such as a personal computer, and a program execution control method for controlling execution of a program in the information processing apparatus.

2. Description of the Related Art

In recent years, personal computers which can be driven by batteries have been developed. In this type of personal computers, a power management technology for reducing power consumption is utilized.

In addition, there has recently been a demand for enhancement of the processing performance of the personal computer, for example, because of the need to process multimedia data, such as motion video data, in real time. Thus, the adoption of a multi-processor system configuration has been promoted also in personal computers.

Jpn. Pat. Appln. KOKAI Publication No. 11-202988 discloses a technique wherein in a case where a high processing performance is not needed in a multiprocessor system including a plurality of CPUs, the operation of one or more CPUs is stopped or suspended, thereby reducing power consumption of the entire system while satisfying a processing performance that is needed in the system.

The technique of KOKAI No. 11-202988, however, relates to a scheme of obtaining a power-saving effect in a case where a high processing performance is not needed in the system, and no power-saving effect can be obtained in a case where a high processing performance is needed in the system.

In addition, in the system of KOKAI No. 11-202988, it is presupposed that a plurality of CPUs have the same architecture, and no consideration is given to a heterogeneous multiprocessor system including different kinds of processors.

In the heterogeneous multiprocessor system, the main role of each processor is predetermined, and a specific kind of process is assigned only to a processor with an excellent processing performance for the specific kind of process. In usual cases, the respective processors have different kinds of instruction sets. Thus, a process, which is described by using a certain instruction set, is executable only by a processor corresponding to this instruction set.

If the operation of a certain processor is simply stopped, a process which is described by using the instruction set that is supported by this processor is no longer executable. Thus, in the case where execution of a process, which is described by using an instruction set that is supported by a certain processor, is needed, the operation of this processor cannot practically be stopped even in the situation that the power consumption of the system needs to be reduced.

Moreover, in the case where the amount of processes of the same kind is large, the processing load concentrates on a specific processor which supports the instruction set that is used for describing these processes. In this case, it is possible, for example, that a process which requires real-time execution, such as a motion video data reproducing process, cannot normally be executed.

Therefore, it is necessary to realize a novel function for achieving power saving in a system including different kinds of processors and enhancement of the processing efficiency of this system.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an external appearance of a computer according to an embodiment of the invention;

FIG. 2 is an exemplary block diagram showing an example of the system configuration of the computer shown in FIG. 1;

FIG. 3 is an exemplary block diagram showing a functional structure of an AV application program which is executed by the computer shown in FIG. 1;

FIG. 4 is an exemplary block diagram showing another example of the system configuration of the computer shown in FIG. 1;

FIG. 5 is an exemplary view for explaining the features of processors which are provided in the computer shown in FIG. 1;

FIG. 6 shows an example of assignment of processes to the processors in the computer shown in FIG. 1;

FIG. 7 shows another example of the assignment of processes to the processors in the computer shown in FIG. 1;

FIG. 8 is an exemplary flow chart illustrating the procedure of a motion video playback process which is executed by the computer shown in FIG. 1;

FIG. 9 shows an example of the relationship between software and hardware in the computer shown in FIG. 1;

FIG. 10 shows still another example of the system configuration of the computer shown in FIG. 1; and

FIG. 11 is an exemplary flow chart illustrating the procedure of a motion video playback process which is applied to the system shown in FIG. 10.

### DETAILED DESCRIPTION

Various embodiments according to the invention will be described hereinafter with reference to the accompanying drawings. In general, according to one embodiment of the invention, there is provided an information processing apparatus comprising: a first processor which has a first instruction set; a second processor which has a second instruction set that is different from the first instruction set, and which is configured to execute a given arithmetic process at a higher speed than the first processor; a storage unit which stores a program including a first program module which is described by using the second instruction set and causes the second processor to execute a first process including the arithmetic process, and a second program module which is described by using the first instruction set and causes the first processor to execute a process which is the same as the first process; and a control unit which has a first mode in which the first program module is assigned to the second processor, thereby causing the second processor to execute the first process, and a second mode in which the second program module is assigned to the first processor, thereby causing the first processor to execute the process that is the same as the first process, the control unit being configured to switch a mode for executing the program between the first mode and the second mode.

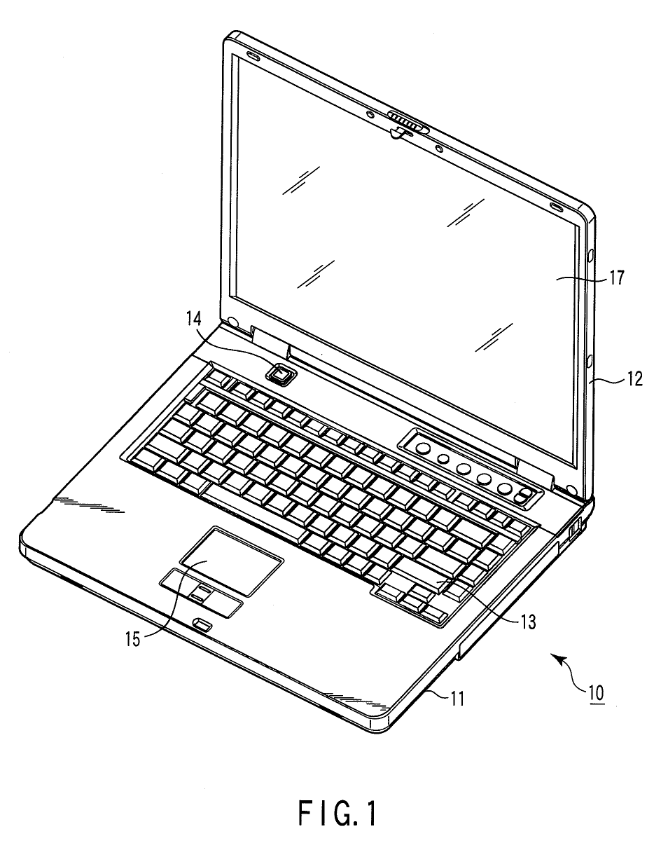

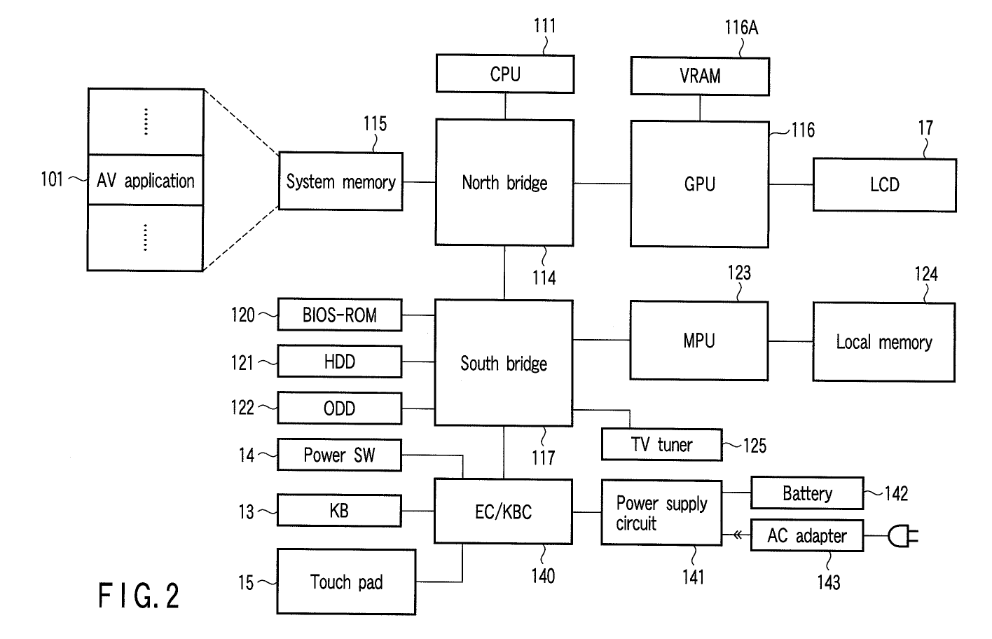

Referring to FIG. 1 and FIG. 2, the structure of an information processing apparatus according to the embodiment of the invention is described. The information processing apparatus is realized, for example, as a battery-powerable notebook-type portable personal computer 10.

FIG. 1 is a perspective view showing the computer 10 in the state in which a display unit thereof is opened. The computer 10 comprises a computer main body 11 and a display unit 12. A display device that is composed of an LCD (Liquid Crystal Display) 17 is built in the display unit 12.

The display unit 12 is attached to the computer main body 11 such that the display unit 12 is freely rotatable between an open position where a top surface of the computer main body 11 is exposed and a closed position where the top surface of the main body 11 is covered by the display unit 12. The computer main body 11 has a thin box-shaped casing in which a battery can detachably be attached.

A keyboard 13, a power button switch 14 for powering on/off the computer 10 and a touch pad 15 are disposed on the top surface of the computer main body 11.

Next, referring to FIG. 2, the system configuration of the computer 10 is described.

The computer 10, as shown in FIG. 2, comprises a CPU 111, a north bridge 114, a system memory (also referred to as “main memory”) 115, a graphics processing unit (GPU) 116, a south bridge 117, a BIOS-ROM 120, a hard disk drive (HDD) 121, an optical disc drive (ODD) 122, a media processing unit (MPU) 123, a local memory 124, a TV tuner 125, an embedded controller/keyboard controller IC (EC/KBC) 140, and a power supply circuit 141.

The computer 10 is a heterogeneous multiprocessor system in which three different kinds of processors, namely, the CPU 111, GPU 116 and MPU 123, are provided, as described above. The CPU 111, GPU 116 and MPU 123 have mutually different instruction sets. In addition, the CPU 111, GPU 116 and MPU 123 have mutually different architectures.

The CPU 111 is a processor (main processor) that is provided for controlling the operation of the computer 10. The CPU 111 executes an operating system and various application programs, which are loaded in the system memory 115 from the HDD 121. In the computer 10, an AV application program 101 is preinstalled in a storage unit, such as the HDD 121, as one of application programs which are loaded in the system memory 115 and executed. The AV application program 101 is a program for a playback/recording process of broadcast program data, and playback of motion video data such as DVD titles.

The CPU 111 functions as a general-purpose processor, and mainly executes a control process such as an ordinary application/operating system process, and not a special arithmetic process such as a vector arithmetic process. The CPU 111 also executes a BIOS (Basic Input/Output System) that is stored in the BIOS-ROM 120. The BIOS is a program for hardware control. The BIOS also has a function of controlling various system states of the computer 10.

The north bridge 114 is a bridge device that connects a local bus of the CPU 111 and the south bridge 117. The north bridge 114 includes a memory controller that access-controls the main memory 115. The north bridge 114 is connected to the GPU 116 via, e.g. a PCI Express bus.

The GPU 116 is a graphics processor (first sub-processor) which has a graphics arithmetic function and generates a video signal which forms a screen image to be displayed on a display device, such as the LCD 17, that is used as a display monitor of the computer 10. The GPU 116 has an instruction set which is different from the instruction set of the CPU 111 that is the general-purpose processor. The GPU 116 can execute a 2-D or 3-D graphics arithmetic process, including a vector arithmetic operation, at a higher speed than the CPU 111. The GPU 116 can also execute an image-quality improving process for improving the quality of video that is to be displayed on the display device (e.g. a filtering process for smoothing, a white/black enhancement process, an interlace/progressive conversion process, a scaling process, an LCD over-drive process, etc.), a decoding process of decoding compression-encoded motion video data, and an encoding process of compression-encoding motion video data. In order to cause the GPU 116 to execute processes such as vector arithmetic process, an image-quality improving process and a motion video encoding/decoding process, a purpose-specific program module (binary code) which is described by using the instruction set of the GPU 116 is necessary. A video memory (VRAM) 116A is used as a working memory of the GPU 116.

The south bridge 117 includes an IDE (Integrated Drive Electronics) controller or a Serial ATA controller for controlling the hard disk drive (HDD) 121 and optical disc drive (ODD) 122. The MPU 123 and the TV tuner 125 are connected to the south bridge 117.

The MPU 123 is a processor (second sub-processor) which mainly executes a motion video decoding/encoding process, and has an instruction set which is different from each of the instruction sets of the CPU 111 and GPU 116. The MPU 123 is configured to execute an arithmetic process (e.g. motion video decoding and motion video encoding) for processing a motion video data stream at a higher speed than the CPU 111 and GPU 116. The local memory 124 is used as a working memory of the MPU 123. In order to cause the MPU 123 to execute the arithmetic process for processing a motion video data stream, a purpose-specific program module (binary code) which is described by using the instruction set of the MPU 123 is necessary.

The TV tuner 125 receives broadcast program data which is broadcast by a broadcast signal. The TV tuner 125 is composed of an analog TV tuner which receives broadcast program data that is broadcast by an analog broadcast signal, or a digital TV tuner which receives broadcast program data that is broadcast by a ground digital broadcast signal.

The embedded controller/keyboard controller IC (EC/KBC) 140 is a 1-chip microcomputer in which an embedded controller for power management and a keyboard controller for controlling the keyboard (KB) 13 and touch pad 15 are integrated. The EC/KBC 140 is always supplied with operation power from the power supply circuit 141 even in the state in which the computer 10 is powered off.

The EC/KBC 140 has a function of powering on/off the computer 10 in response to the user's operation of the power button switch 14. The power on/off control of the computer 10 is executed by cooperation of the EC/KBC 140 and power supply circuit 141. The power supply circuit 141 uses power from a battery 142 which is mounted in the computer main body 11 or power from an AC adapter 143 which is connected to the computer main body 11 as an external power, thereby generating operation powers to the respective components.

The computer 10 has a battery driving mode in which the computer 10 is driven by the battery 142, and an AC adapter driving mode (also simply referred to as “AC driving mode”) in which the computer 10 is driven by the external power. In the case where the AC adapter 143 is connected to the computer 10, that is, in the case where external power is supplied to the computer 10, the power supply circuit 141 generates operation power by using the external power from the AC adapter 143, and thus the computer 10 operates in the AC adapter driving mode. On the other hand, in the case where the AC adapter 143 is not connected to the computer 10, that is, in the case where external power is not supplied to the computer 10, the power supply circuit 141 generates operation power by using the power from the battery 142, and thus the computer 10 operates in the battery driving mode.

The EC/KBC 140 is provided with a register which stores status data that indicates in which of the battery driving mode and AC adapter driving mode the computer 10 is currently operating. The status data can be referred to from the OS or application programs.

Normally, at the time of battery driving, compared to the time of AC adapter driving, it is necessary to keep the power consumption of the entire system at a low level because of the limitation of discharge current. For example, even if the system is operated with a performance of 100% at the time of AC adapter driving, it is considered necessary to lower the performance to 70% at the time of battery driving. Thus, the computer 10 is provided with a function of setting one of the plural processors, e.g. MPU 123, in a state (sleep state) in which power consumption is lower than in the normal operation state (working state). The MPU 123 is set in a sleep state at the time of the battery driving mode. The sleep state is a state in which the operation of the MPU 123 is stopped and the MPU 123 executes no instruction/process. In this case, a process, such as a motion video decoding process, which is to be assigned to the MPU 123, is executed by another processor, for instance, the GPU 116.

In order to realize this, the AV application program 101 includes a first program module for causing the MPU 123 to execute a process (e.g. decoding process) including a predetermined arithmetic process, and a second program module for causing the GPU 116 to execute the same process. The first program module is described by using the instruction set of the MPU 123, and the second program module is described by using the instruction set of the GPU 116. The AV application program 101 has a mode (first mode) in which the AV application program 101 assigns the first program module to the MPU 123, thereby causing the MPU 123 to execute, e.g. the motion video decoding process, and a mode (second mode) in which the AV application program 101 assigns the second program module to the GPU 116, thereby causing the GPU 116 to execute, e.g. the motion video decoding process. The AV application program 101 can selectively switch these two modes. Thus, in the AC adapter driving mode, the first mode is selected and the MPU 123 is caused to execute, e.g. the motion video decoding process. Thereby, the system performance can be utilized at maximum. In the battery driving mode, the second mode is selected and the GPU 116 is caused to execute, e.g. the motion video decoding process. Thereby, the operation of the MPU 123 is stopped and power saving can be realized, without causing a problem in the motion video playback process that requires real-time processing.

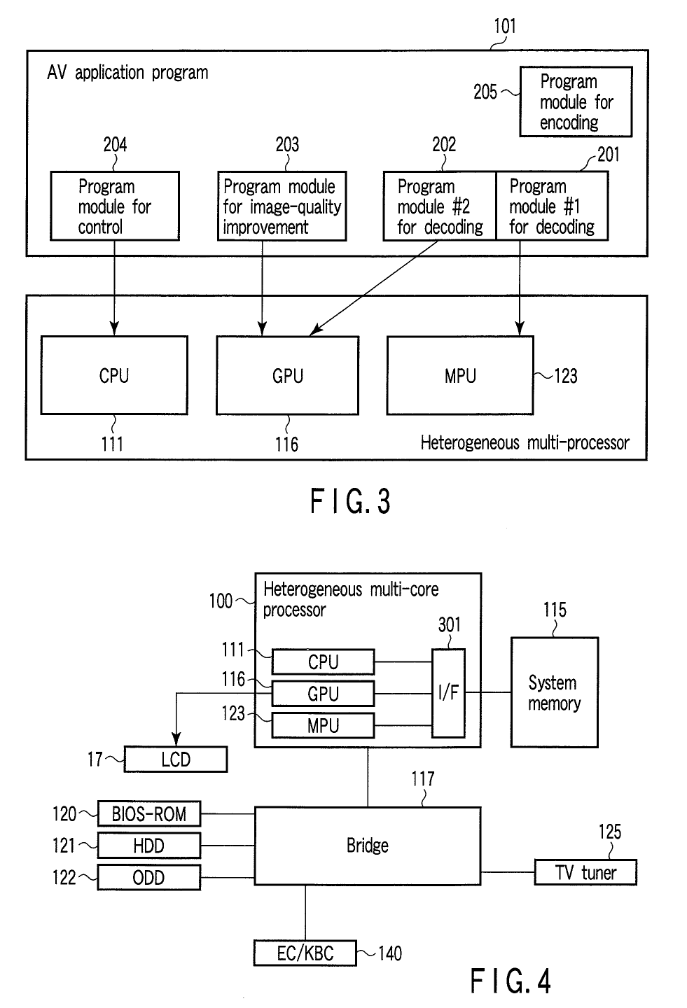

Next, referring to FIG. 3, a specific example of the functional structure of the AV application program 101 is described.

The AV application program 101 includes a program module 201 for decoding, a program module 202 for decoding, a program module 203 for image-quality improvement, a program module 204 for control, and a program module 205 for encoding.

The program module 201 for decoding is a program module (task) for causing the MPU 123 to execute the motion video decoding process, and is described by using the instruction set that is supported by the MPU 123. The program module 202 for decoding is a program module (task) for causing the GPU 116 to execute the motion video decoding process, and is described by using the instruction set that is supported by the GPU 116.

The program module 203 for image-quality improvement is a program module (task) for causing the GPU 116 to execute an image-quality improving process as a video process that is to be applied to motion video data which is decoded by the motion video decoding process. The program module 203 for image-quality improvement is described by using the instruction set that is supported by the GPU 116.

The program module 204 for control is a program module for causing the CPU 111 to execute control of the behavior of the AV application program 101, that is, control of processes such as the motion video decoding process and image-quality improving process. The program module 204 for control is described by using the instruction set that is supported by the CPU 116. In accordance with, e.g. system status data, the program module 204 for control can effect switching of the mode for executing the AV application program 101 between the first mode in which the program module 201 for decoding is assigned to the MPU 123 and the second mode in which the program module 202 for decoding is assigned to the GPU 116.

The program module 205 for encoding is a program module (task) for causing the MPU 123 to execute a motion video encoding process for compression-encoding motion video data, and is described by using the instruction set that is supported by the MPU 123.

For example, in the case where it is necessary to simultaneously execute the motion video decoding process and motion video encoding process, as in the case of recording broadcast program data while playing back the broadcast program data, if both the motion video decoding process and motion video encoding process are assigned to the MPU 123, the processing load would concentrate upon the MPU 123 and the recording and playback processes could not be executed in real time. Thus, in the case where the motion video decoding process and motion video encoding process need to be executed at the same time, the program module 204 for control assigns the program module 202 for decoding to the GPU 116, instead of assigning the program module 201 for decoding to the MPU 123. Thereby, the recording and playback processes can be executed in real time.

FIG. 4 shows another example of the system configuration of the computer 10.

In FIG. 4, there is provided a heterogeneous multi-core processor 100 in which the CPU 111, GPU 116 and MPU 123 are integrated on a single chip. The CPU 111, GPU 116 and MPU 123 are realized as cores, respectively. The heterogeneous multi-core processor 100 also includes a memory interface 301, and the CPU 111, GPU 116 and MPU 123 access the system memory 115 via the memory interface 301.

With the structure shown in FIG. 4, too, at the time of battery driving, for example, the supply of a clock signal to the MPU 123 may be stopped or the supply of the operation power to the MPU 123 may be stopped, thereby to halt the operation of the MPU 123.

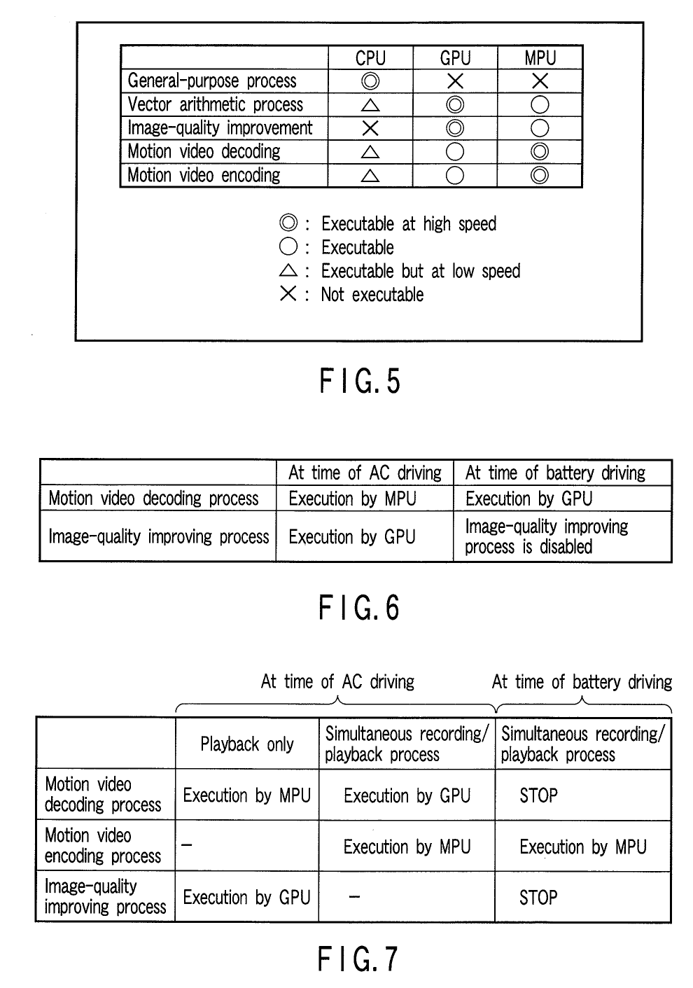

Next, referring to FIG. 5, the features of the three processors, i.e. the CPU 111, GPU 116 and MPU 123, are explained.

As has been described above, since the CPU 111 is a general-purpose processor, the CPU 111 can execute at high speed such general-purpose processes as the OS or ordinary applications. However, the processing speed of the vector arithmetic process, motion video decoding and motion video encoding is low, and the image-quality improving process cannot practically be executed.

The GPU 116 can execute at high speed the vector arithmetic process and the image-quality improving process, and can also execute the motion video decoding and motion video encoding. However, the general-purpose process, which requires high flexibility, cannot practically be executed.

The MPU 123 can execute the motion video decoding and motion video encoding at a higher speed than the CPU 111 and GPU 116, and can also execute the vector arithmetic process and image-quality improving process although the processing speed is lower than the GPU 116. However, the general-purpose process, which requires high flexibility, cannot practically be executed.

FIG. 6 shows the operations of the respective processors according to the power mode states of the computer 10.

At the time of AC adapter driving mode, since the system can use the 100% performance, the MPU 123 can be operated. Thus, in the case of executing the motion video playback process, the TV application program 101 assigns the program module 201 for decoding to the MPU 123, thereby causing the MPU 123 to execute the motion video decoding process, and assigns the program module 203 for image-quality improving to the GPU 116, thereby causing the GPU 116 to execute the image-quality improving process. Thereby, motion video can be played back with an appropriate image quality.

On the other hand, at the time of battery driving mode, it is difficult to operate the MPU 123 because of the limitation of the battery capacity. Since the motion video decoding process needs to be executed in real time, if the CPU 111 is caused to execute the motion video decoding process, a problem such as frame dropping would occur. Thus, the TV application program 101 assigns the program module 202 for decoding to the GPU 116, thereby causing the GPU 116 to execute the motion video decoding process, and omits at least a part of the image-quality improving process that is to be executed by the GPU 116. In this manner, the process that is executed by the MPU 123 at the time of AC adapter driving is switched to the GPU 116 at the time of battery driving, and at least a part of the image-quality improving process that is to be executed by the GPU 116 is omitted. Thereby, the real-time processing can be maintained although the image quality lowers.

FIG. 7 shows the operations of the respective processors in the case of playing back motion video and in the case of simultaneously executing playback and recording of motion video.

Even at the time of AC adapter driving, the processing performance of each processor is limited. Thus, there may be a case in which playback and recording of motion video cannot be executed at the same time. In the case of executing only motion video playback, the motion video decoding process is executed by the MPU 123. However, in the case of simultaneously executing playback and recording, the GPU 116 is made to execute the motion video decoding process (playback) and the MPU 123 is made to execute the motion video encoding process (recording). At least a part of the image-quality improving process, which is to be executed by the GPU 116, is omitted. Thereby, the real-time processing of recording and playback can be executed although the image quality lowers.

At the time of battery driving, playback and recording of motion video cannot be executed in real time. For example, priority is placed on the recording of, e.g. a broadcast program, the MPU 123 is caused to execute the motion video encoding process (recording) and the motion video playback process, i.e. the motion video decoding process, and image-quality improving process are halted.

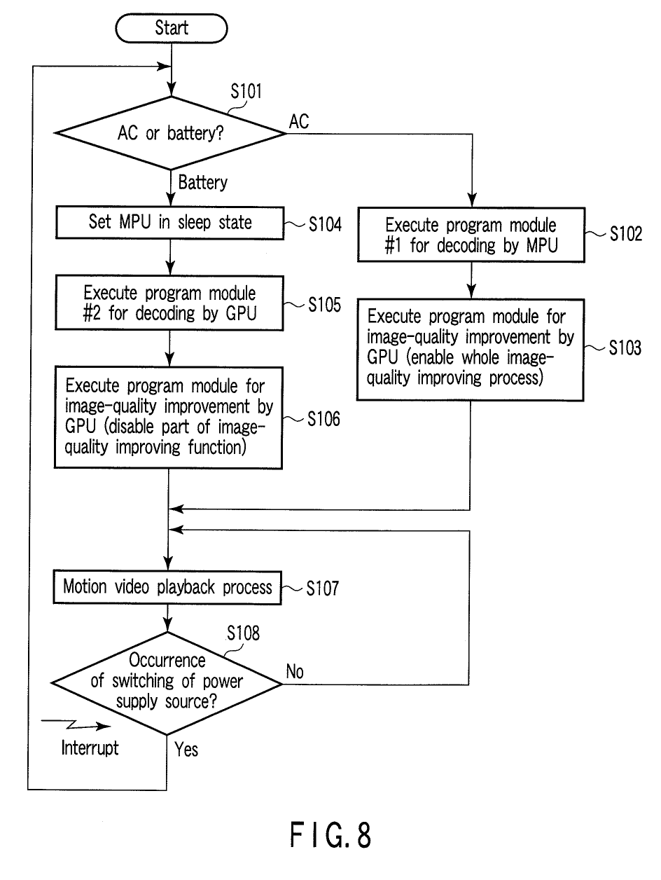

Next, referring to a flow chart of FIG. 8, the procedure of the motion video playback process, which is executed by the AV application program 101, is described.

In the case of executing the motion video playback process, the AV application program 101 is first input from the HDD 121 and loaded in the system memory 115 by the CPU 111. The CPU 111 executes the program module 204 for control of the AV application program 101.

To start with, the program module 204 for control refers to the register in the EC/KBC 140 and determines whether the computer 10 is operating in the AC adapter driving mode or in the battery driving mode (block S101).

In the case of the AC adapter driving mode, the program module 204 for control calls the program module 201 for decoding, which is a decoding program for the MPU 123, and assigns the program module 201 for decoding to the MPU 123 via, for example, the OS, thereby causing the MPU 123 to execute the motion video decoding process (block S102). In block S102, for example, the program module 201 for decoding in the system memory 115 is transferred to the local memory 124 of the MPU 123, and the MPU 123 executes the program module 201 for decoding.

Further, the program module 204 for control calls the program module 203 for image-quality improvement, and assigns the program module 203 for image-quality improvement to the GPU 116 via, for example, the OS, thereby causing the GPU 116 to execute the image-quality improving process that is a video process which is to be applied to decoded motion video data (block S103). In block S103, for example, the program module 203 for image-quality improvement in the system memory 115 is transferred to the GPU 116 or VRAM 116A by the CPU 111 or GPU 116, and the GPU 116 executes the program module 203 for image-quality improvement.

Thereby, the motion video playback process is executed by the cooperation of the MPU 123 and GPU 116 (block S107).

On the other hand, in the case of the battery driving mode, the program module 204 for control cooperates with, for instance, the BIOS or OS, and sets the MPU 123 in a sleep state (block S104). That is, if the computer 10 is operating in the battery driving mode, the program module 204 for control transits the MPU 123 from the working state to the sleep state, in order to reduce the power consumption of the computer 10. The program module 204 for control calls the program module 202 for decoding, which is a decoding program for the GPU 116, and assigns the program module 202 for decoding to the GPU 116 via, for example, the OS, thereby causing the GPU 116 to execute the motion video decoding process (block S105). In block S105, for example, the program module 202 for decoding in the system memory 115 is transferred to the GPU 116 or VRAM 116A by the CPU 111 or GPU 116, and the GPU 116 executes the program module 202 for decoding.

Further, the program module 204 for control calls the program module 203 for image-quality improvement, and assigns the program module 203 for image-quality improvement to the GPU 116 via, for example, the OS, thereby causing the GPU 116 to execute the image-quality improving process that is a video process which is to be applied to decoded motion video data (block S106). In this case, for example, under the control of the program module 204 for control, at least a part of the image-quality improving process is omitted on an as-needed basis. Such omission can be executed by providing a function of skipping a specified process in the program module 203 for image-quality improvement. Needless to say, under the control of the program module 204 for control, the whole function of the image-quality improving process may be disabled.

Thereby, the motion video playback process is executed by the GPU 116 (block S107).

If switching of the power supply source, such as attachment/detachment of the AC adapter, occurs during the motion video playback process, a system management interrupt signal SMI is issued from the EC/KBC 140 to the CPU 111. In response to the occurrence of the system management interrupt SMI, the BIOS informs the program module 204 for control of the occurrence of the switching of the power supply source. Responding to the information, the program module 204 for control determines the presence/absence of the switching of the power supply source. If the switching of the power supply source occurs (YES in block S108) the program module 204 for control returns to the process of block S101, and determines whether the present power supply mode is the AC adapter driving mode or the battery driving mode. In accordance with the determination result, the program module 204 for control switches the processor, which is to execute the decoding process, between the GPU 116 and the MPU 123, and alters, as needed, the content of the image-quality improving process.

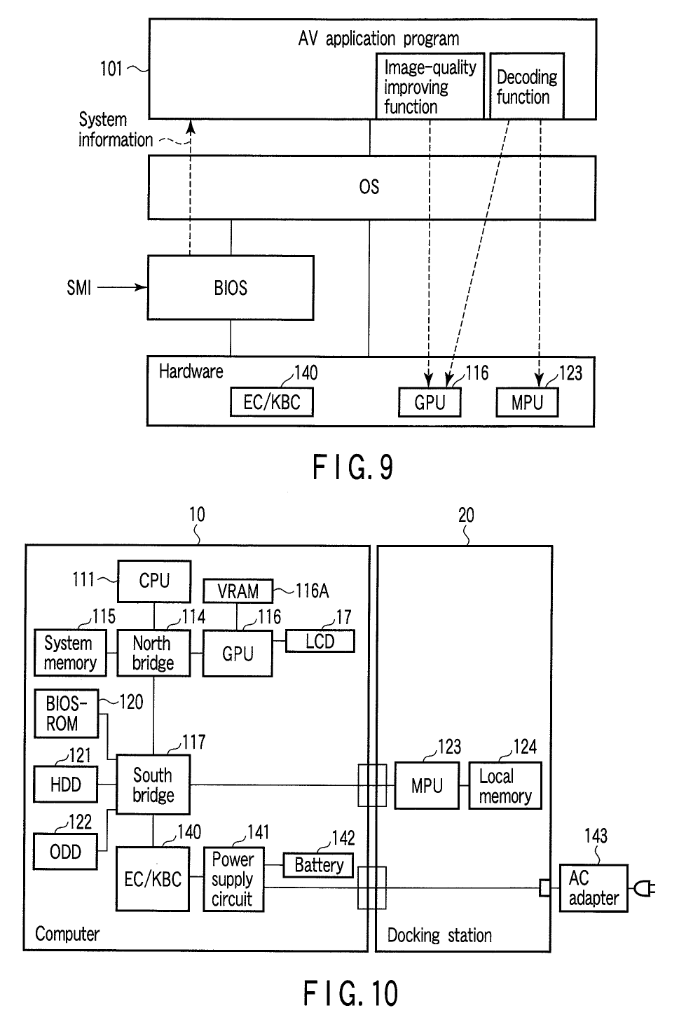

FIG. 9 shows an example of the relationship between software and hardware.

The AV application program 101 can access, via the OS or directly, the GPU 116, MPU 123 and EC/KBC 140. The AV application program 101 has an interface with the BIOS, and can acquire various system information, such as a current power supply mode, from the BIOS.

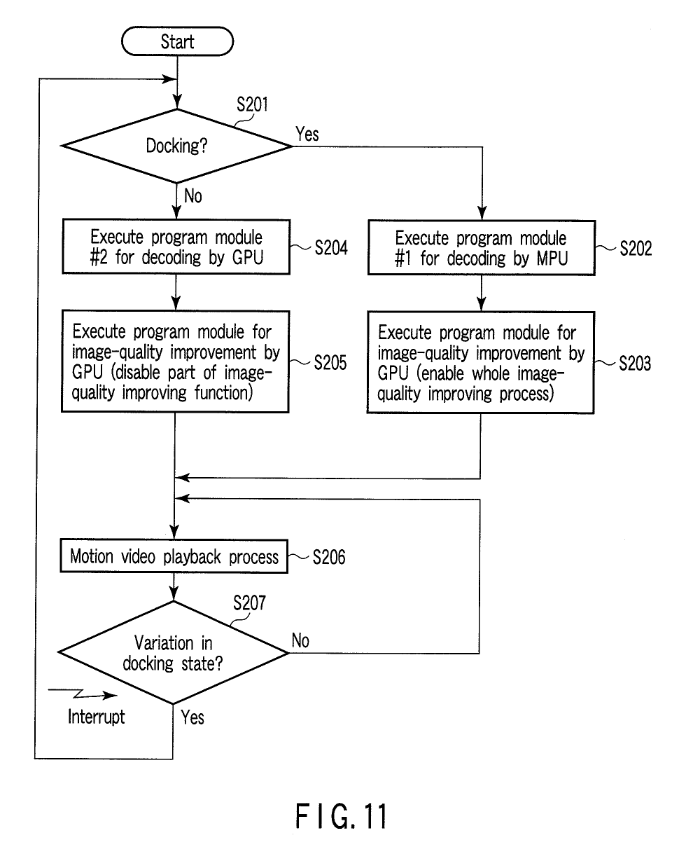

FIG. 10 shows another example of the system configuration of the computer 10.

In FIG. 10, the MPU 123 and local memory 124 are provided in a docking station 20, or an expansion unit, to which the computer main body 11 is detachably attached. In the state in which the computer main body 11 is attached to the docking station 20, the MPU 123 and local memory 124 are usable as hardware resources of the computer 10, and the computer 10 operates in the AC driving mode by power that is supplied from the AC adapter 143 which is connected to the docking station 20.

In this structure, the contents of processes, which are assigned to the respective processors, are changed in accordance with the presence/absence of docking.

Next, referring to a flow chart of FIG. 11, the procedure of the motion video playback process, which is applied to the system configuration of FIG. 10, is described.

To start with, the program module 204 for control of the AV application program 101 communicates with, for instance, the BIOS, and determines whether the docking station 20 is connected to the computer 10 (block S201).

In the case where the docking station 20 is connected, the program module 204 for control calls the program module 201 for decoding, which is a decoding program for the MPU 123, and assigns the program module 201 for decoding to the MPU 123 via, for example, the OS, thereby causing the MPU 123 to execute the motion video decoding process (block S202). Further, the program module 204 for control calls the program module 203 for image-quality improvement, and assigns the program module 203 for image-quality improvement to the GPU 116 via, for example, the OS, thereby causing the GPU 116 to execute the image-quality improving process that is a video process which is to be applied to decoded motion video data (block S203). Thereby, the motion video playback process is executed by the cooperation of the MPU 123 and GPU 116 (block S206).

On the other hand, in the case where the docking station 20 is not connected, the program module 204 for control calls the program module 202 for decoding, which is a decoding program for the GPU 116, and assigns the program module 202 for decoding to the GPU 116 via, for example, the OS, thereby causing the GPU 116 to execute the motion video decoding process (block S204). Further, the program module 204 for control calls the program module 203 for image-quality improvement, and assigns the program module 203 for image-quality improvement to the GPU 116 via, for example, the OS, thereby causing the GPU 116 to execute the image-quality improving process that is a video process which is to be applied to decoded motion video data (block S205). In this case, for example, under the control of the program module 204 for control, at least a part of the image-quality improving process is omitted on an as-needed basis. Needless to say, under the control of the program module 204 for control, the whole function of the image-quality improving process may be disabled. Thus, the motion video playback process is executed by the GPU 116 (block S206).

If a variation in the docking state, such as attachment/detachment of the docking station 20, occurs during the motion video playback process, a system management interrupt signal SMI, for instance, is issued from the EC/KBC 140 to the CPU 111. In response to the occurrence of the system management interrupt SMI, the BIOS informs the program module 204 for control of the occurrence of the variation in the docking state. Responding to the information, the program module 204 for control determines the presence/absence of the variation in the docking state. If a variation in the docking state occurs (YES in block S207), the program module 204 for control returns to the process of block S201, and determines the current docking state. In accordance with the determination result, the program module 204 for control switches the processor, which is to execute the decoding process, between the GPU 116 and the MPU 123, and alters, as needed, the content of the image-quality improving process.

As has been described above, in the present embodiment, the specific process, such as the motion video decoding process, can selectively be assigned to the GPU 116 and MPU 123 and executed in accordance with various system states such as the power supply source, the presence/absence of the MPU and the load on the MPU. Therefore, even in the state in which the operation of the MPU 123 is stopped, the playback process of motion video data can normally be carried out, and the power saving of the system can be realized. Furthermore, in the case where the motion video decoding process is executed by the GPU 116, a part or the entirety of the video process, which is to be applied to the decoded motion video data, is omitted and the load on the GPU 116 is reduced. Thereby, the performance of the GPU 116 can be concentrated on the motion video decoding process, and the occurrence of, e.g. frame dropping can be prevented.

In the case where recording and playback of motion video are to be simultaneously executed, the processor that is to execute the motion video decoding process is changed from the MPU 123 to the GPU 116, and the MPU 123 is caused to execute the motion video encoding process. Thereby, the increase in load on the MPU 123 can be prevented, and the system process efficiency of the whole system can be improved.

The above-described embodiment relates to the case in which the decoding process is selectively executed by the MPU 123 or GPU 116. However, the process that is selectively executed by the MPU 123 or GPU 116 is not limited to the decoding process. A process, the arithmetic processing performance for which is different between a GPU and an MPU, may selectively be executed by the MPU 123 or GPU 116, and thereby the same advantageous effects as in the embodiment can be obtained.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a first processor comprising a first instruction set;
a second processor comprising a second instruction set that is different from the first instruction set, the second processor configured to execute a given arithmetic process at a higher speed than the first processor;
a storage unit configured to store a program comprising a first program module described in the second instruction set, the first module configured to cause the second processor to execute a first process including the arithmetic process, and a second program module described in the first instruction set, the second module configured to cause the first processor to execute a process which is the same as the first process; and
a control unit comprising a first mode in which the first program module is assigned to the second processor, thereby causing the second processor to execute the first process, and a second mode in which the second program module is assigned to the first processor, thereby causing the first processor to execute the process that is the same as the first process, the control unit being configured to switch a mode for executing the program between the first and the second mode.

2. The information processing apparatus of claim 1, further comprising a determination unit configured to determine whether the information processing apparatus is supplied power from a battery or from an external power source,
wherein the control unit is configured to select the first mode if the information processing apparatus is supplied power from the external power source, thereby causing the program to be executed in the first mode, and is configured to select the second mode if the information processing apparatus is supplied power from the battery, thereby causing the program to be executed in the second mode and to switch a state of the second processor from a working state to a state in which power consumption of the second processor is lower than in the working state.

3. The information processing apparatus of claim 2, wherein the first process is a decoding process for decoding compression-encoded video data,
the program further comprises a third program module described in the first instruction set and configured to cause the first processor to execute a video post-process to be applied to video data decoded by the decoding process, and
the control unit configured to assign, in the first mode, the first and the third program module to the second and the first processor, respectively, thereby causing the second and the first processor to execute the decoding process and the video post-process, and the control unit configured to assign, in the second mode, the second program module to the first processor, thereby causing the first processor to execute the decoding process and omitting at least a part of the video post-process configured to be executed by the first processor.

4. The information processing apparatus of claim 3, wherein the first processor is a graphics processor comprising a graphics arithmetic function, the graphics processor configured to generate a video signal for forming a screen configured to be displayed on a display device, and
the second processor is a media processor configured to execute an arithmetic process for processing a video data stream at a higher speed than the first processor.

5. An information processing apparatus comprising:
a main processor comprising a first instruction set;
a first sub-processor comprising a second instruction set, the first sub-processor configured to execute a graphics arithmetic process at a higher speed than the main processor;
a second sub-processor comprising a third instruction set, the second sub-processor configured to execute an arithmetic process for decoding compression-encoded video data at a higher speed than the main processor and the first sub-processor;
a storage unit configured to store a program including a first program module described in the third instruction set, the first module configured to cause the second sub-processor to execute a decoding process for decoding compression-encoded video data, a second program module described in the second instruction set, the second module configured to cause the first sub-processor to execute the decoding process, a third program module described in the second instruction set, the third module configured to cause the first sub-processor to execute a video post-process to be applied to video data decoded by the decoding process, and a program module for controlling described in the first instruction set;
a determination unit configured to determine whether the information processing apparatus is supplied power from a battery or from an external power source; and
a control unit configured to cause the main processor to execute the program module for controlling, thereby controlling execution of the first to third program modules, the control unit assigning, in a case where the information processing apparatus is supplied power from the external power source, the first and the third program module to the second and the first sub-processor respectively, and assigning, in a case where the information processing apparatus is supplied power from the battery, the second and the third program module to the first sub-processor, and switching a state of the second sub-processor from a working state to a state in which power consumption of the second sub-processor is lower than in the working state.

6. The information processing apparatus of claim 5, wherein the control unit is configured to omit at least a part of the video post-process configured to be executed by the first sub-processor, in a case where the information processing apparatus is supplied power from the battery.

7. A program execution control method for controlling execution of a program in an information processing apparatus comprising a first processor comprising a first instruction set, and a second processor comprising a second instruction set that is different from the first instruction set, the second processor configured to execute a given arithmetic process at a higher speed than the first processor, the method comprising:
inputting a program comprising a first program module described in the second instruction set, the first module configured to cause the second processor to execute a first process comprising the arithmetic process, and a second program module described in the first instruction set, the second module configured to cause the first processor to execute a process which is the same as the first process; and
switching a mode for executing the program between a first mode in which the first program module is assigned to the second processor, thereby causing the second processor to execute the first process, and a second mode in which the second program module is assigned to the first processor, thereby causing the first processor to execute the process that is the same as the first process.

8. The program execution control method of claim 7, further comprising determining whether the information processing apparatus is supplied power from a battery or from an external power source,
wherein the mode switching for executing the program comprises:
selecting the first mode, if the information processing apparatus is supplied power from the external power source, thereby causing the program to be executed in the first mode, and
selecting the second mode, if the information processing apparatus is supplied power from the battery, thereby causing the program to be executed in the second mode and to switch a state of the second processor from a working state to a state in which power consumption of the second processor is lower than in the working state.

9. The program execution control method of claim 8, wherein the first process is a decoding process for decoding compression-encoded video data, the program further comprises a third program module described in the first instruction set, the third module configured to cause the first processor to execute a video post-process to be applied to video data decoded by the decoding process, the mode switching for executing the program further comprises:
assigning, in the first mode, the first and the third program module to the second and the first processor, respectively, thereby causing the second and the first processor to execute the decoding process and the video post-process, and
assigning, in the second mode, the second program module to the first processor, thereby causing the first processor to execute the decoding process and omitting at least a part of the video post-process to be executed by the first processor.
